(19) United States
(12) Patent Application Publication
(10) Pub. No.: US 2010/0011344 A1
(43) Pub. Date: Jan. 14, 2010

(54) METHOD MAKING IT POSSIBLE TO VARY THE NUMBER OF EXECUTIONS OF COUNTERMEASURES IN AN EXECUTED CODE

(75) Inventor: Pascal Guterman, Roquevaire (FR)

Correspondence Address: BUCHANAN, INGERSOLL & ROONEY PC, POST OFFICE BOX 1404, ALEXANDRIA, VA, 22313-1404, US

(73) Assignee: GEMALTO SA

(21) Appl. No.: 12/519,502

(22) PCT Filed: Dec. 3, 2007
(86) PCT No.: PCT/EP07/63148

§ 371 Date: Jun. 16, 2009

(30) Foreign Application Priority Data
Dec. 18, 2006 (EP) 06301265.2

(51) Int. Cl. G06F 9/44

(52) U.S. Cl. 717/124

(57) ABSTRACT

The present invention relates to the field of securing and protecting the execution of a source code by a processing unit of an item of electronic equipment, as well as the associated devices, for example chip cards. The invention presents a method for securing the execution of a source code by a processing unit of an item of electronic equipment, the method comprising steps of inserting dummy operations, in which some of the dummy operations do not execute in full.

The present invention relates to the field of securing and protecting the execution of a computer code by a processing unit of an item of electronic equipment, as well as the devices associated thereto, for example, chip cards.

Chip cards are the subject of many hacking attempts, through either active or passive attacks. An active attack consists in injecting a fault for physically disturbing the integrated circuit of the chip card, with a view to modifying the behavior of the latter and to trap the software code towards another type of execution.

On the contrary, a passive attack for example through a side-channel, the hacker tries to make a statistical analysis of measurable magnitudes in the chip such as the electric supply current or the electromagnetic radiations emitted by the chip in order to master or to deduce the chip execution tasks.

In order to remedy such attacks, it is known to use and insert, upon the execution of a command, random delays, i.e. delays the duration of which is selected in a random or pseudo-random way, as a countermeasure to such attacks in order to make these more complex. As a matter of fact, the presence of such random delays makes it difficult to determine the moment at which the fault must be injected by the pirate, upon the execution of a process and prevents the pirate from being synchronized to carry out side channel measurements.

In the present description and in the claims, “source code” means a sequence of executable instructions forming the whole or a part of a computer application.

Similarly, an “executed code” will mean a sequence of instructions really played by the processor upon the execution of the whole or a part of the corresponding application.

It is known to insert into the source coder portions of the code the result of which is not necessary for the normal execution of the code in question. These code portions are generally called “decoys”. The characteristic of these decoys, during a side channel analysis, consists in that they look like true important sequences of code.

The common aim of such countermeasures (decoys or random delays) consist in making attacks from the outside more difficult by preventing the pirate from understanding and/or predicting with accuracy the execution of the program.

Inserting such countermeasures at multiple locations during the execution of a source code by the chip is frequent. More particularly, it has been found to secure the execution of delicate or risky operations (such as the writing/reading in or from the memory, a cryptographic calculation, a decision making algorithm) with such countermeasures. As a matter of fact, these delicate operations are much solicited by the pirates and it seems right to insert many countermeasures all along the execution of the source code, prior to or during such delicate operations.

A drawback of this solution lies in the fact that it is possible to identify the presence of these countermeasures during the side channel analysis in spite of the efforts to make them as little visible as possible. These countermeasures are generally positioned close to the critical sequences of the source code and their detection may allow positioning the attacks as close to the crucial points as possible.

The present invention aims at solving this disadvantage by providing to vary the number of countermeasures really accomplished from one execution to the other.

For this purpose, the present invention firstly aims at a method for securing the execution of a source code by a processing unit of an item of electronic equipment, with this method comprising a step of inserting dummy operations, a part of the dummy operations not executing in full. in the following description, these particular dummy operations will be called “partial countermeasures”.

The number of partial countermeasures may vary between two executions of the program in question. These variations may occur according to calculation rules, or in an unpredictable way. A possible way to obtain an unpredictable item of information is to generate it randomly.

To reach this goal, the invention provides cutting the countermeasures into two parts, one part which will be called the introductory part and one part which will be called the body. The countermeasures which execute only partially, execute only the introductory part thereof.

Preferably, when the number of partial countermeasures is defined, the selection of the countermeasures becoming partial can be done according to defined rules or unpredictably.

Other characteristics and advantages of the invention will appear upon reading the following description which is made hereinunder as an indication and not a limitation, and referring to the appended drawings wherein:

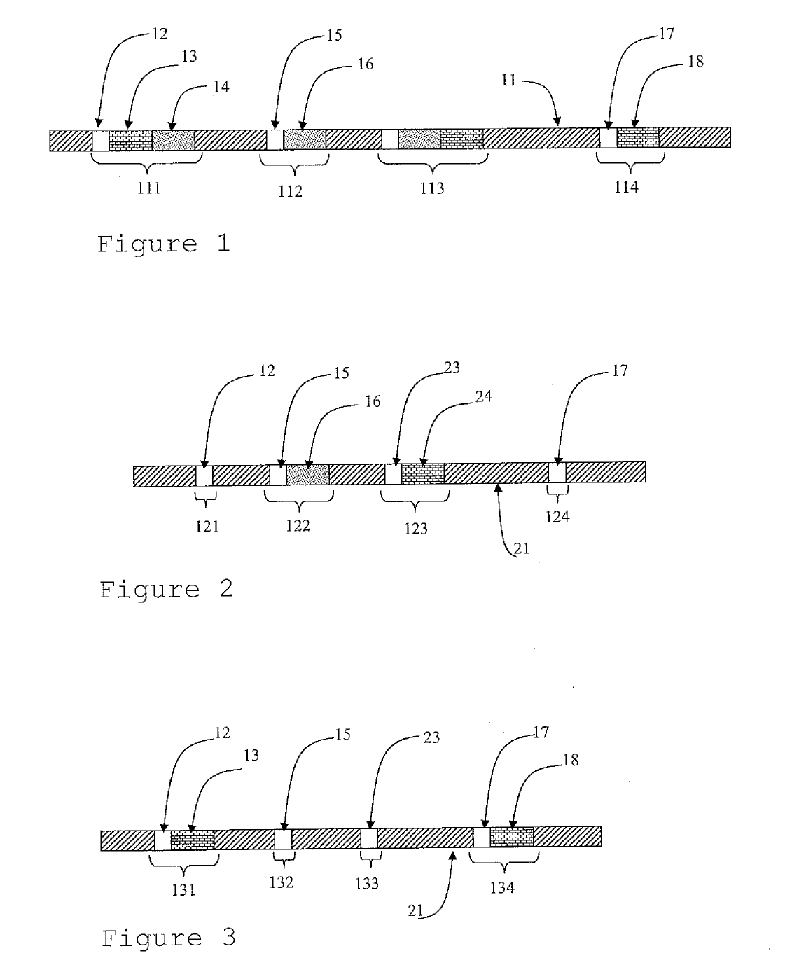

FIG. 1 shows an exemplary source code portion containing countermeasures according to the invention;

FIGS. 2 and 3 show the really executed code originating from the same portion of code as in FIG. 1, but upon two distinct executions.

FIG. 1 shows an exemplary source code portion containing countermeasures according to the invention.

This figure shows a source code 11 wherein a countermeasure 112 has been inserted. The latter includes a body 16 preceded by an introductory part 15. Similarly, a second countermeasure 114 includes a body 18 preceded by the introductory part 17 thereof. A third particular countermeasure 111 is composed of two bodies 13 and 14 and the introductory part 12 thereof. This Figure further includes a fourth countermeasure 113 having a composition identical to the countermeasure 111.

In this exemplary embodiment, four countermeasures 111 to 114 are thus inserted into the source code 11. According to the invention, these countermeasures can be divided into two parts. It should be noted that the introductory part is always executed by the application. In order to prevent the identification of the countermeasures by a hacker, it any, these introductory parts must be reduced to the minimum, as regards their size.

In a preferred embodiment, the introductory part will be limited to the calling of instructions already called regularly in the course of the code. These current instructions are, for example, modifications in the general purpose register of the microprocessor, or modifications in internal variables. The aim is that, during a side channel analysis, the introductory parts of the countermeasures cannot be distinguished from the executed code.

In this embodiment, particular countermeasures 111 and 113 can be seen. These countermeasures have the particularity of having several bodies 13 and 14 for only one introductory part 12. Each body 13 and 14 is an independent countermeasure, for example a delay or a decoy. Thus, the introductory part 12 will decide to execute the body or not, but will also decide which of the available bodies will be executed.

FIG. 2 shows an execution of the code of FIG. 1, wherein the number of countermeasures to be activated is two. This Figure shows an executed code 21, wherein are included: one countermeasure 122 including a body 16 and an introductory part 15, a second countermeasure 123 including a body 24 and the introductory part 23 thereof, as well as two other particular countermeasures, a countermeasure 121 which includes only one introductory part 12, and one countermeasure 124 including only the introductory part 17. In this execution, it can be seen that the countermeasures 121 and 124 are executed only partially, in fact only the introductory parts have been executed. The countermeasure 122 is executed in full and the countermeasure 123 is executed with one of the possible bodies.

FIG. 3 shows another execution of the code of FIG. 1, wherein the number of countermeasures to be activated is two. This Figure shows an executed code 21, wherein are included a first countermeasure 131 including a body 13 and an introductory part 12, a second countermeasure 134 including a body 18 and the introductory part 17 thereof, as well as two other particular countermeasures, a countermeasure 132 including only one introductory part 15, and one countermeasure 133 including one introductory part 23. During this execution, the countermeasures 132 and 133 are executed only partially, in fact only the introductory part thereof has been executed. The countermeasure 134 executed normally and the countermeasure 131 executed with one of the possible bodies.

When looking at FIGS. 2 and 3, it can be seen that from one execution to the other, all the countermeasures can be changed whether in the location, in the code, in the duration or even in the nature thereof. This set of countermeasures will make a side channel analysis of the code much more difficult. In addition, it will be extremely complex to find trap points, since the consecutive executions of the same code will be very different.

In one embodiment, the countermeasures used are random delays and abridged in Rnd in the following. This function can be divided into two parts:
an introductory part, which contains the call for the functions, some memory treatments, if any,
a function body, which contains the activation of the random generator and the real drawing of the random variable.

Upon the creation of the code, the programmers made a point to insert a large number of Rnds almost everywhere in the code. For example, approximately three times as many Rnds are inserted as in a so-called protected standard code, which is protected against side channel attacks, not implementing the present invention. Thus, by executing in full only one third of these Rnds, the thus protected code will be, upon the execution thereof, almost as fast as the same code protected by conventional Rnds, all executed in full but with a highly increased safety.

In one embodiment, upon the initiation of the program, two random values are drawn:
A “nbr” value which will make it possible to define the number of Rnds which will execute in full;
A “wch” value which will make it possible to designate which rounds will execute in full.

Thus, upon the execution of a code, upon each execution of a Rnd, the Rnd function itself, during the execution of the introductory part thereof, tests the wch and nbr values, and decides whether it will let the body of the function execute or not.

Another embodiment of the invention relates to material countermeasures. A known utilization of countermeasures consists in making dummy activations of peripheral members such as cryptographic accelerators (AC) and or random numbers generators. The invention provides to position a large number of AC potential activation sites which can be compared to the introductory parts of countermeasures. The AC, which can be compared to the body of the countermeasure, will be activated only at some locations.

In one preferred embodiment of the invention, everything is made so that it is impossible to predict which of the positions will be activated between two executions.

In one preferred embodiment of the invention, the invention will be implemented in a portable device such as a chip card.

1. A method for securing the execution of a source code by a processing unit of an item of electronic equipment, said method including steps of inserting dummy operations wherein a part of said dummy operations does not execute in full.

2. A method according to claim 1, wherein the number of dummy operations not executing in full varies between two executions of said source code.

3. A method according to claim 2, wherein said number of dummy operations not executing in full is recalculated upon each execution of said source code.

4. A method according to claim 2, wherein said varying number of dummy operations not executing in full varies unpredictably from one execution to the other of said source code.

5. A method according to claim 1, wherein said dummy operations include an introductory part and a body.

6. A method according to claim 5, wherein only the introductory part of the dummy operations not executing in full is executed.

7. A method according to claim 1, wherein the selection of the dummy operations not executing in full is redefined upon each execution of said source code.

8. A method according to claim 1, wherein the selection of the dummy operations not executing in full is unpredictable.

9. A portable item in that implements the method according to claim 1.
